(19) United States
(12) Patent Application Publication
(10) Pub. No.: US 2014/0019247 A1
(43) Pub. Date: Jan. 16, 2014

(54) SYSTEMS AND METHODS FOR DETERMINING LOCATION OF A MOBILE DEVICE BASED ON AN AUDIO SIGNAL

(71) Applicant: CIRRUS LOGIC, INC., Austin, TX (US)

(72) Inventor: John L. Melanson, Austin, TX (US)

(73) Assignee: CIRRUS LOGIC, INC., Austin, TX (US)

(21) Appl. No.: 13/728,347

(22) Filed: Dec. 27, 2012

Related U.S. Application Data
(60) Provisional application No. 61/669,720, filed on Jul. 10, 2012.

(51) Int. Cl. H04W 24/00

(52) U.S. Cl. 705/14.58; 455/457; 455/456.3

(57) ABSTRACT

A mobile device includes a display, a microphone, and a controller all within an enclosure sized and shaped such that the enclosure is readily transported on a person of a user of the mobile device. The microphone is configured to receive an audio signal from an audio signal source. The controller is coupled to the microphone and the display, and configured to, based at least on information included in the audio signal, determine a delay between a transmission of the audio signal from the audio signal source to receipt of the audio signal by the microphone. The controller is further configured to, based at least on the delay, determine a geographical location of the mobile device. The controller is also configured to, based on the geographical location of the mobile device, display geographical information to the display indicative of the geographical location.

### RELATED APPLICATION

The present disclosure claims priority to U.S. Provisional Patent Application Ser. No. 61/669,720, filed Jul. 10, 2012, which is incorporated by reference herein in its entirety.

### FIELD OF DISCLOSURE

The present disclosure relates in general to a mobile device, and more particularly, to determining a geographical location of a mobile device based on a delay between transmission of the audio signal from the audio signal source to receipt of the audio signal by a microphone of the mobile device.

### BACKGROUND

Increasingly, mobile devices (e.g., smart phones, tablets, handheld computers, etc.) are employing location-based services. Generally, location-based services are implemented on mobile devices by an executable program of instructions that determine a geographical location of the mobile device and based on such determined geographic location, generate information regarding persons, places, or things within proximity of the mobile device. For example, location-based services may be able to identify a location of a person or object, such as discovering a nearest banking cash machine, tracking parcels and vehicles, and communicating information (e.g., coupons or advertising) to a user of a mobile device based on such user's current location.

Using existing approaches, location-based services generally use satellite-based positioning system (e.g., Global Positioning System (GPS), Global Navigation Satellite System (GLONASS), etc.) capabilities of a mobile device to determine a geographical location of the mobile device. In some situations, other sensors of the mobile device (e.g., accelerometers, gyroscopes, barometers, radio signals from cellular base stations, televisions signals, IEEE 802.11 signals, etc.) may augment a satellite-based positioning system in order to determine a geographical location of the mobile device. However, such sensors may have disadvantages, in that they may consume relatively large amounts of power in operation (thus negatively affecting battery life) and/or may not provide desired accuracy for certain applications. One example of an application in which traditional approaches lack needed accuracy is in the context of determining a mobile device's location within a building and proximity to objects in such building, as in the case of determining a location of the mobile device in a grocery store and directing information to the mobile device (e.g., coupons or advertising for a product proximate to the mobile device) based on such location. Such an application may require accuracy within approximately a meter for a period of up to approximately one hour, which may be beyond the limitations of traditional approaches to location-based services.

### SUMMARY

In accordance with the teachings of the present disclosure, the disadvantages and problems associated with determining a location of a mobile device have been reduced or eliminated.

In accordance with embodiments of the present disclosure, a mobile device may include an enclosure, a display within the enclosure, a microphone within the enclosure, and a controller within the enclosure. The enclosure may be sized and shaped such that the enclosure is readily transported on a person of a user of the mobile device. The microphone may be configured to receive an audio signal from an audio signal source. The controller may be coupled to the microphone and the display, and configured to, based at least on information included in the audio signal, determine a delay between transmission of the audio signal from the audio signal source to receipt of the audio signal by the microphone. The controller may further be configured to, based at least on the delay, determine a geographical location of the mobile device. The controller may also be configured to, based on the geographical location of the mobile device, display geographical information to the display indicative of the geographical location.

In accordance with these and other embodiments of the present disclosure, a method may include receiving, at a microphone within an enclosure of a mobile device sized and shaped such that the enclosure is readily transported on a person of a user of the mobile device, an audio signal from an audio signal source. The method may also include based at least on information included in the audio signal, determining a delay between transmission of the audio signal from the audio signal source to receipt of the audio signal by the microphone. The method may additionally include based at least on the delay, determining a geographical location of the mobile device. The method may further include based on the geographical location of the mobile device, displaying geographical information to a display of the mobile device indicative of the geographical location.

In accordance with these and other embodiments of the present disclosure, an article of manufacture may include a computer readable medium and computer-executable instructions carried on the computer readable medium, the instructions readable by one or more controllers. The instructions, when read and executed, may cause the one or more controllers to: (i) receive, from a microphone within an enclosure of a mobile device sized and shaped such that the enclosure is readily transported on a person of a user of the mobile device, an audio signal from an audio signal source; (ii) based at least on information included in the audio signal, determine a delay between transmission of the audio signal from the audio signal source to receipt of the audio signal by the microphone; (iii) based at least on the delay, determine a geographical location of the mobile device; and (iv) based on the geographical location of the mobile device, display geographical information to a display of the mobile device indicative of the geographical location.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are exemplary and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example mobile device, in accordance with embodiments of the present disclosure;

FIG. 2 illustrates a system for determining a geographical location of a mobile device based on an audio signal, in accordance with embodiments of the present disclosure; and

FIG. 3 illustrates a flow chart of an exemplary method for determining a geographical location of a mobile device based on an audio signal, in accordance with embodiments of the present disclosure.

### DETAILED DESCRIPTION

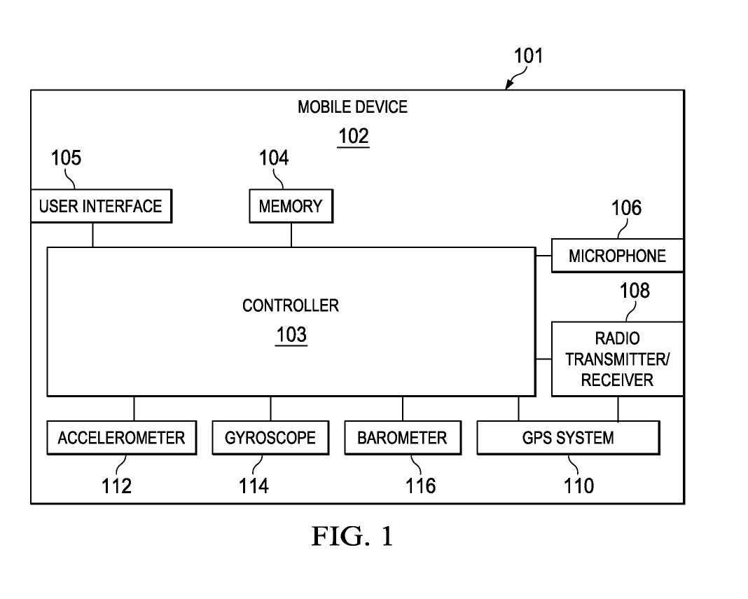

FIG. 1 illustrates a block diagram of an exemplary mobile device 102, in accordance with embodiments of the present disclosure. As shown in FIG. 1, mobile device 102 comprises an enclosure 101, a controller 103, a memory 104, a user interface 105, a microphone 106, a radio transmitter/receiver 108, a GPS system 110, an accelerometer 112, a gyroscope 114, and a barometer 116.

Enclosure 101 comprises any suitable housing, casing, or other enclosure for housing the various components of mobile device 102. Enclosure 101 may be constructed from plastic, metal, and/or any other suitable materials. In addition, enclosure 101 may be sized and shaped such that mobile device 102 is readily transported on a person of a user of mobile device 102. Accordingly, mobile device 102 includes but is not limited to a smart phone, a tablet computing device, a handheld computing device, a personal digital assistant, a notebook computer, or any other device that may be readily transported on a person of a user of mobile device 102.

Controller 103 is housed within enclosure 101 and includes any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interprets and/or executes program instructions and/or process data. In some embodiments, controller 103 interprets and/or executes program instructions and/or process data stored in memory 104 and/or other computer-readable media accessible to controller 103.

Memory 104 may be housed within enclosure 101, may be communicatively coupled to controller 103, and includes any system, device, or apparatus configured to retain program instructions and/or data for a period of time (e.g., computer-readable media). Memory 104 may include random access memory (RAM), electrically erasable programmable read-only memory (EEPROM), a Personal Computer Memory Card International Association (PCMCIA) card, flash memory, magnetic storage, opto-magnetic storage, or any suitable selection and/or array of volatile or non-volatile memory that retains data after power to mobile device 102 is turned off.

User interface 105 may be housed at least partially within enclosure 101, may be communicatively coupled to controller 103, and comprises any instrumentality or aggregation of instrumentalities by which a user may interact with user mobile device 102. For example, user interface 105 may permit a user to input data and/or instructions into user mobile device 102 (e.g., via a keypad and/or touch screen), and/or otherwise manipulate mobile device 102 and its associated components. User interface 105 may also permit mobile device 102 to communicate data to a user, e.g., by way of a display device.

Microphone 106 may be housed at least partially within enclosure 101, may be communicatively coupled to controller 103, and comprises any system, device, or apparatus configured to convert sound incident at microphone 106 to an electrical signal that may be processed by controller 103.

Radio transmitter/receiver 108 may be housed within enclosure 101, may be communicatively coupled to controller 103, and includes any system, device, or apparatus configured to, with the aid of an antenna, generate and transmit radio-frequency signals as well as receive radio-frequency signals and convert the information carried by such received signals into a form usable by controller 103. Radio transmitter/receiver 108 may be configured to transmit and/or receive various types of radio-frequency signals, including without limitation, cellular communications (e.g., 2G, 3G, 4G, LTE, etc.), short-range wireless communications (e.g., BLUETOOTH), commercial radio signals, television signals, satellite radio signals (e.g., GPS), Wireless Fidelity, etc.

GPS system 110 may be housed within enclosure 101, may be communicatively coupled to controller 103 and/or radio transmitter/receiver 108, and includes any system, device, or apparatus configured to process (with or without the aid of controller 103) GPS satellite signals received by radio transmitter/receiver 108 and determine a time and/or location of mobile device 102.

Accelerometer 112 may be housed within enclosure 101, may be communicatively coupled to controller 103, and includes any system, device, or apparatus configured to measure acceleration (e.g., proper acceleration) experienced by mobile device 102.

Gyroscope 114 may be housed within enclosure 101, may be communicatively coupled to controller 103, and includes any system, device, or apparatus configured to measure an orientation of mobile device 102 (e.g., based on an angular momentum experienced by mobile device 102).

Barometer 116 may be housed within enclosure 101, may be communicatively coupled to controller 103, and includes any system, device, or apparatus configured to measure an atmospheric pressure experienced by mobile device 102.

Although specific exemplary sensors are depicted above in FIG. 1 as being integral to mobile device 102 (e.g., microphone 106, radio transmitter/receiver 108, GPS system 110, accelerometer 112, gyroscope 114, and barometer 116), a mobile device 102 in accordance with this disclosure may comprise one or more sensors not specifically enumerated above, and/or may exclude one or more sensors specifically enumerated above.

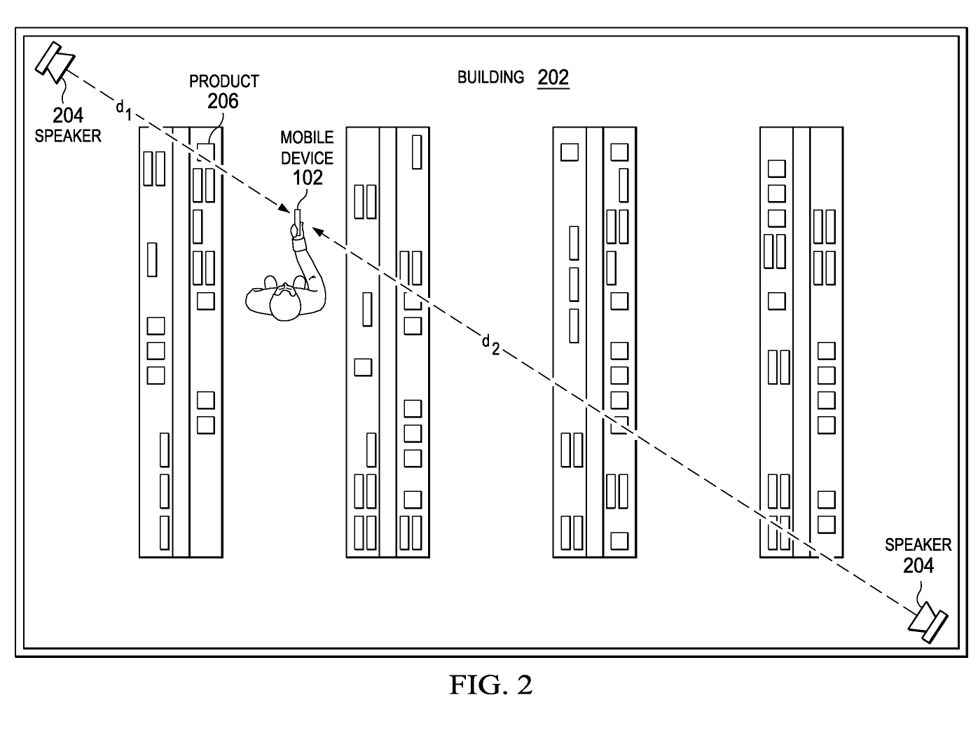

In operation, microphone 106 and controller 103 receive an audio signal from an audio signal source, determine a delay between transmission of the audio signal from the audio signal source to receipt of the audio signal by the microphone based at least on information included in the audio signal, determine a geographical location of the mobile device based at least on the delay, and display geographical information to the display indicative of the geographical location. To further illustrate this operation of mobile device 102, reference is made to FIG. 2, which illustrates a system for determining a geographical location of mobile device 102 based on an audio signal in accordance with embodiments of the present disclosure.

In FIG. 2, a plan view of a building 202 is depicted in which a user of mobile device 102 enters and traverses the floor of such building 202. In some instances, building 202 is a retail store in which the user browses for and/or purchases products, such as a product 206. Building 202 includes one or more audio signal sources, such as audio speakers 204, for example.

In order to determine a geographical location of mobile device 102, each of the one or more audio speakers 204 communicates a respective audio signal. Such audio signal comprises, or may be a part of background music played by speakers 204, a signal at a frequency range above that of human hearing, modification of existing background music (e.g., with a phase shift pattern applied to the background music), or any other suitable signal.

Microphone 106 of mobile device 102 receives the one or more audio signals and communicates such signals to controller 103. For each of the audio signals, controller 103 may determine a delay between transmission of the audio signal from its respective audio speaker 204 and the receipt of the audio signal. Such delays from each audio speaker 204 are determined in any suitable manner. For example, a time basis or clock for the mobile device 102 and/or the audio speakers 204 may be synchronized by comparison to another source, such as a radio signal, BLUETOOTH signal, Wireless Fidelity signal, television signal, GPS signal, etc. that communicate a time reference to mobile device 102 and/or audio speakers 204.

Based on each delay, controller 103 determines a distance between the mobile device 102 and each audio speaker 204. For example, as shown in FIG. 2, distances d₁ and d₂ are determined by controller 103. Based on the one or more determined distances from audio speakers 204, controller 103 determines a geographical location of mobile device 102. With one audio speaker 204, a location of mobile device 102 on a circular arc is determined, the circular arc having a radius equal to the determined distance of mobile device 102 to the singular audio speaker 204. A precise location on such arc is determined based on location measurements from other sensors of mobile device 102 (e.g., radio transmitter/receiver 108, GPS system 110, accelerometer 112, gyroscope 114, and barometer 116). With two audio speakers 204, two dimensional coordinates are determined from audio signals originating from the audio speakers 204. In such a case, greater location is also achieved based on location measurements from other sensors of mobile device 102. For example, barometric pressure measurements from barometer 116 is used to determine which floor of a building a mobile device 102 is located, while audio signals are used to determine a location on such floor.

With multiple audio signal sources, the audio signals are multiplexed in one or more of many different ways so that controller 103 determines the source of the individual audio signals. For example, in some embodiments, the signals originating from each audio speaker 204 are similar, but multiplexed in time. In a specific example of such embodiment, each audio speaker 204 in order takes turns playing an ultrasonic chirp for a period of time (e.g., 1 millisecond). As another example, the individual audio sources produce different signals broadcast simultaneously. In yet other embodiments, the signals originating from each audio speaker 204 are similar, but modified in different manners. In such embodiments, each audio speaker 204 generates identical background music, but with a phase periodically delayed or advanced in each of the speakers with differing patterns. Other approaches include phase modulation, adding encoded signals to audio broadcasted from individual audio speakers (e.g., noise signals or other encoded signals to audio generated by each audio speaker 204, a different noise pattern from each speaker 204, creating signal notches at particular frequencies on the signal from each speaker 204, etc.).

Based on the geographical location, controller 103 may display geographical information to a display of user interface 105 of mobile device 102, the geographical information indicative of the geographical location. In some embodiments, the geographical information comprises location-based information, the location-based information based on a proximity of the geographical location to a second geographical location other than the audio signal source. In these embodiments, the location-based information comprises navigational information for navigating a user of the mobile device from the geographical location to the second geographical location. In these and other embodiments, the second geographical location are indicative of an approximate geographical location of a consumer product (e.g., product 206 depicted in FIG. 2), and the location-based information comprises an advertisement for the consumer product and/or a coupon for the consumer product. In such embodiments, location of the product may be known based on a map or database of building 202 setting forth the approximate locations within building 202 of various products 206. In other embodiments, the second geographical location is indicative of a second mobile device, the geographical location of which may be determined in a similar manner, and the geographical information is used to enable users of each mobile device to find each other or play a game.

Using a similar technique to that described herein, a speaker in a mobile device is used, one or more microphones receives an audio signal generated by the speaker, and the distance between the mobile device and each of the one or more microphones is determined in order to determine a geographical location of the mobile device.

If multiple microphones 106 are available, whether on a single mobile device 102 or a plurality of mobile devices 102, additional information regarding the audio signal sources can be gathered, such as the direction of the audio signal source (e.g., person talking, car horn, musical instrument, thunderstorm, or other sound) from the microphones 106. By working in concert, multiple mobile devices 102 find a location of the audio signal source and the relative location of the mobile devices. Such information may be used for navigation, gaming, or other uses.

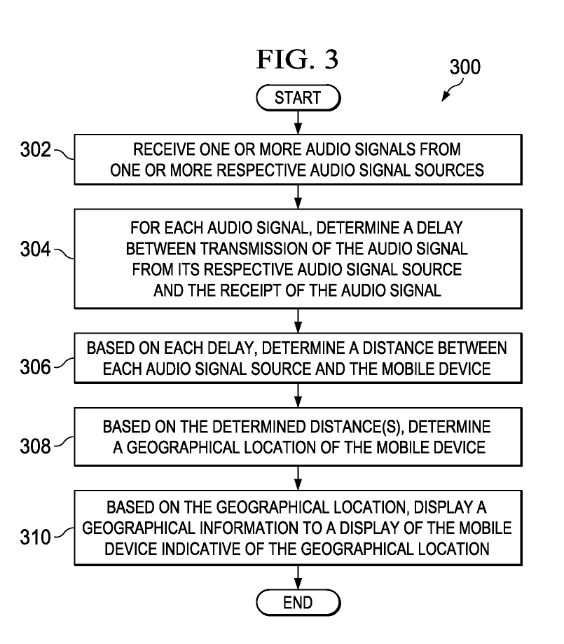

FIG. 3 illustrates a flow chart of an exemplary method for determining a geographical location of a mobile device based on an audio signal, in accordance with embodiments of the present disclosure. According to one embodiment, method 300 begins at step 302. As noted above, teachings of the present disclosure are implemented in a variety of configurations of mobile device 102. As such, the preferred initialization point for method 300 and the order of the steps comprising method 300 may depend on the implementation chosen.

At step 302, a microphone (e.g., microphone 106) of a mobile device (e.g., mobile device 102) receives one or more audio signals from one or more respective audio signal sources (e.g., audio speakers 204). At step 304, for each audio signal, a controller (e.g., controller 103) of the mobile device determines a delay between transmission of the audio signal from its perspective audio signal source and the receipt of the audio signal.

At step 306, based on each delay, the controller determines a distance between each audio signal source and the mobile device. At step 308, based on the one or more determined distances, the controller determines a geographical location of the mobile device. At step 310, based on the geographical location, the controller causes the mobile device to display geographical information to a display of the mobile device indicative of the geographical location.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 is implemented using mobile device 102 or any other system operable to implement method 300. In certain embodiments, method 300 may be implemented partially or fully in software and/or firmware embodied in computer-readable media.

The use of sound for determination of location in certain situations, particularly inside a building, may be desirable as compared to using other location determination techniques (e.g., GPS or radio), as the speed of propagation of sound is, compared with the speed of propagation of electromagnetic waves, more on the scale of the accuracy required to effectively provide geographical location-based information inside of a building. The use of sound may also require less power consumption than radio or other sensors and does not require sensors in addition to what are generally standard in mobile devices.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. A mobile device comprising:
an enclosure sized and shaped such that the enclosure is readily transported on a person of a user of the mobile device;
a display within the enclosure;
a microphone within the enclosure for receiving an audio signal from an audio signal source; and
a controller within the enclosure, coupled to the microphone and the display, and configured to:
based at least on information included in the audio signal, determine a delay between a transmission of the audio signal from the audio signal source to receipt of the audio signal by the microphone;
based at least on the delay, determine a geographical location of the mobile device; and
based on the geographical location of the mobile device, display geographical information to the display indicative of the geographical location.

2. The mobile device of claim 1, wherein the geographical information comprise location-based information based on a proximity of the geographical location to a second geographical location other than the audio signal source.

3. The mobile device of claim 2, wherein the location-based information further comprises navigational information for navigating a user of the mobile device from the geographical location to the second geographical location.

4. The mobile device of claim 2, wherein the second geographical location is indicative of an approximate geographical location of a consumer product.

5. The mobile device of claim 4, wherein the location-based information comprises at least one of an advertisement for the consumer product and a coupon for the consumer product.

6. The mobile device of claim 1, wherein the mobile device comprises one of a smart phone, a tablet computing device, a handheld computing device, a personal digital assistant, and a notebook computer.

7. The mobile device of claim 1, wherein the audio signal source is an audio speaker.

8. The mobile device of claim 1, wherein:
the microphone further receives a second audio signal from a second audio signal source; and
the controller is further configured to:
based at least on information included in the second audio signal, determine a second delay between a transmission of the second audio signal from the second audio signal source to receipt of the second audio signal by the microphone; and
based at least on the delay and the second delay, determine a geographical location of the mobile device.

9. The mobile device of claim 1, wherein the mobile device further comprises at least one sensor other than the microphone and the controller is further configured to, based at least on the delay and sensor information received by the at least one sensor, determine the geographical location of the mobile device.

10. The mobile device of claim 9, wherein the at least one sensor comprises at least one of a radio transmitter/receiver, a GPS system, an accelerometer, a gyroscope, and a barometer.

11. The mobile device of claim 1, wherein the audio signal is an encoded signal added to audio broadcasted from the audio signal source.

12. A method comprising:
receiving, at a microphone within an enclosure of a mobile device sized and shaped such that the enclosure is readily transported on a person of a user of the mobile device, an audio signal from an audio signal source;
based at least on information included in the audio signal, determining a delay between a transmission of the audio signal from the audio signal source to receipt of the audio signal by the microphone;
based at least on the delay, determining a geographical location of the mobile device; and
based on the geographical location of the mobile device, displaying geographical information to a display of the mobile device indicative of the geographical location.

13. The method of claim 12, wherein the geographical information further comprises location-based information based on a proximity of the geographical location to a second geographical location other than the audio signal source.

14. The method of claim 13, wherein the location-based information further comprises navigational information for navigating a user of the mobile device from the geographical location to the second geographical location.

15. The method of claim 13, wherein the second geographical location is indicative of an approximate geographical location of a consumer product.

16. The method of claim 15, wherein the location-based information further comprises at least one of an advertisement for the consumer product and a coupon for the consumer product.

17. The method of claim 12, wherein the mobile device comprises one of a smart phone, a tablet computing device, a handheld computing device, a personal digital assistant, and a notebook computer.

18. The method of claim 12, wherein the audio signal source is an audio speaker.

19. The method of claim 12, further comprising:
receiving, by the microphone, a second audio signal from a second audio signal source;
based at least on information included in the second audio signal, determining a second delay between a transmission of the second audio signal from the second audio signal source to receipt of the second audio signal by the microphone; and
based at least on the delay and the second delay, determining a geographical location of the mobile device.

20. The method of claim 12, wherein the mobile device further comprises at least one sensor other than the microphone and the method further comprises, based at least on the delay and sensor information received by the at least one sensor, determining the geographical location of the mobile device.

21. The method of claim 20, wherein the at least one sensor comprises at least one of a radio transmitter/receiver, a GPS system, an accelerometer, a gyroscope, and a barometer.

22. The method of claim 12, wherein the audio signal is an encoded signal added to audio broadcasted from the audio signal source.

23. An article of manufacture comprising:
a computer readable medium; and
computer-executable instructions carried on the computer readable medium, the instructions readable by one or more controllers, the instructions, when read and executed, for causing the one or more controllers to:
receive, from a microphone within an enclosure of a mobile device sized and shaped such that the enclosure is readily transported on a person of a user of the mobile device, an audio signal from an audio signal source;
based at least on information included in the audio signal, determine a delay between a transmission of the audio signal from the audio signal source to receipt of the audio signal by the microphone;
based at least on the delay, determine a geographical location of the mobile device; and
based on the geographical location of the mobile device, display geographical information to a display of the mobile device indicative of the geographical location.

24. The article of claim 23, the geographical information further comprising location-based information based on a proximity of the geographical location to a second geographical location other than the audio signal source.

25. The article of claim 24, wherein the location-based information further comprises navigational information for navigating a user of the mobile device from the geographical location to the second geographical location.

26. The article of claim 24, wherein the second geographical location is indicative of an approximate geographical location of a consumer product.

27. The article of claim 26, wherein the location-based information further comprises at least one of an advertisement for the consumer product and a coupon for the consumer product.

28. The article of claim 23, wherein the mobile device comprises one of a smart phone, a tablet computing device, a handheld computing device, a personal digital assistant, and a notebook computer.

29. The article of claim 23, wherein the audio signal source is an audio speaker.

30. The article of claim 23, further comprising the instructions for further causing the one or more controllers to:
receive, from the microphone, a second audio signal from a second audio signal source;
based at least on information included in the second audio signal, determine a second delay between a transmission of the second audio signal from the second audio signal source to receipt of the second audio signal by the microphone; and
based at least on the delay and the second delay, determine a geographical location of the mobile device.

31. The article of claim 23, wherein the mobile device further comprises at least one sensor other than the microphone, further comprising the instructions for further causing the one or more controllers to, based at least on the delay and sensor information received by the at least one sensor, determine the geographical location of the mobile device.

32. The article of claim 31, wherein the at least one sensor comprises at least one of a radio transmitter/receiver, a GPS system, an accelerometer, a gyroscope, and a barometer.

33. The article of claim 23, wherein the audio signal is an encoded signal added to audio broadcasted from the audio signal source.

34. A system comprising:
an audio signal source configured to generate an audio signal for receipt by a mobile device having an enclosure sized and shaped such that the enclosure is readily transported on a person of a user of the mobile device, the audio signal including information such that, based on the information, the mobile device:
determines a delay between a transmission of the audio signal from the audio signal source to receipt of the audio signal by the microphone;
based at least on the delay, determines a geographical location of the mobile device; and
based on the geographical location of the mobile device, displays geographical information to a display of the mobile device indicative of the geographical location.

35. The system of claim 34, the geographical information further comprising location-based information based on a proximity of the geographical location to a second geographical location other than the audio signal source.

36. The system of claim 35, wherein the location-based information further comprises navigational information for navigating a user of the mobile device from the geographical location to the second geographical location.

37. The system of claim 35, wherein the second geographical location is indicative of an approximate geographical location of a consumer product.

38. The system of claim 37, wherein the location-based information further comprises at least one of an advertisement for the consumer product and a coupon for the consumer product.

39. The system of claim 34, wherein the mobile device comprises one of a smart phone, a tablet computing device, a handheld computing device, a personal digital assistant, and a notebook computer.

40. The system of claim 34, wherein the audio signal source is an audio speaker.

41. The system of claim 34, further comprising a second audio signal source configured to generate a second audio signal, such that the mobile device further:
receives the second audio signal;
based at least on information included in the second audio signal, determines a second delay between a transmission of the second audio signal from the second audio signal source to receipt of the second audio signal by the microphone; and
based at least on the delay and the second delay, determines a geographical location of the mobile device.

42. The system of claim 34, wherein the audio signal is an encoded signal added to audio broadcasted from the audio signal source.
